(19) United States
(12) Patent Application Publication
(10) Pub. No.: US 2026/0071991 A1
(43) Pub. Date: Mar. 12, 2026

(54) ALL-SOLID-STATE POTASSIUM ION SELECTIVE ELECTRODE, AND METHOD FOR PRODUCING SAME

(71) Applicants: KOA Corporation, Nagano (JP); Tokyo University of Science Foundation, Tokyo (JP)

(72) Inventors: Toshiharu TAKAYAMA, Nagano (JP); Takahiro MATSUI, Nagano (JP); Yuko TAKEI, Nagano (JP); Kazuma AOKI, Nagano (JP); Shinichi KOMABA, Tokyo (JP); Ryoichi TATARA, Tokyo (JP); Kenta ISHIHARA, Tokyo (JP)

(73) Assignees: KOA Corporation, Nagano (JP); Tokyo University of Science Foundation, Tokyo (JP)

(21) Appl. No.: 19/105,926

(22) PCT Filed: Jun. 28, 2023
(86) PCT No.: PCT/JP2023/024062

§ 371 Date: Feb. 24, 2025

(30) Foreign Application Priority Data
Aug. 25, 2022 (JP) 2022-134340

(51) Int. Cl. G01N 27/333

(52) U.S. Cl. CPC G01N 27/3335

(57) ABSTRACT

Provided is a potassium ion-selective electrode with higher stability and a manufacturing method therefor. An all-solid-state potassium ion-selective electrode includes a conductor, an insertion material formed on a surface of the conductor, and a potassium ion-sensitive membrane covering the insertion material. The insertion material is a mixed material containing Prussian blue analogue particles and conductive material particles. The Prussian blue analogue particles are represented by a structural formula KₓFe[Fe(CN)₆]_{y}·nH₂O. The Prussian blue analogue particles have at least partially a monoclinic crystal structure, and x is a number equal to or greater than 1.5 and equal to or less than 2, y is a number greater than 0 and equal to or less than 1, and n is a number equal to or greater than 0.

### TECHNICAL FIELD

The present invention relates to an all-solid-state potassium ion-selective electrode and a manufacturing method therefor.

### BACKGROUND ART

Ion-selective electrodes are used in devices and the like that measure concentration of ions in liquids, and produce a potential change in response to specific ions. They are used in a variety of fields, including environmental technology, medical technology, and agricultural technology.

Ion-selective electrodes that are sensitive to various types of ions are known. Patent Literature 1 discloses magnesium ion-selective electrodes and calcium ion-selective electrodes that contain Prussian blue analogues.

### CITATION LIST

### Patent Literature

Patent Literature 1: JP 2020-46364 A

### SUMMARY OF INVENTION

### Technical Problem

However, with conventional technology, there was a problem in the potassium ion-selective electrodes regarding room for improvement in terms of stability.

The present invention has been made to solve the problem and aims to provide a potassium ion-selective electrode with higher stability and a manufacturing method therefor.

### Solution to Problem

One example of an all-solid-state potassium ion-selective electrode according to the present invention includes a conductor, an insertion material formed on a surface of the conductor, and a potassium ion-sensitive membrane covering the insertion material. The insertion material is a mixed material containing Prussian blue analogue particles and conductive material particles. The Prussian blue analogue particles are represented by a structural formula KₓFe[Fe(CN)₆]_{y}·nH₂O. The Prussian blue analogue particles have at least partially a monoclinic crystal structure, and x is a number equal to or greater than 1.5 and equal to or less than 2, y is a number greater than 0 and equal to or less than 1, and n is a number equal to or greater than 0.

In one example of a method for manufacturing an all-solid-state potassium ion-selective electrode according to the present invention, the all-solid-state potassium ion-selective electrode includes a conductor, an insertion material formed on a surface of the conductor, and a potassium ion-sensitive membrane covering the insertion material. The insertion material is a mixed material containing Prussian blue analogue particles and conductive material particles. The Prussian blue analogue particles are represented by a structural formula KₓFe[Fe(CN)₆]_{y}·nH₂O. The Prussian blue analogue particles have at least partially a monoclinic crystal structure, and x is a number equal to or greater than 1.5 and equal to or less than 2, y is a number greater than 0 and equal to or less than 1, and n is a number equal to or greater than 0. The method includes: a process of forming a compound membrane on the surface of the conductor by supplying a slurry onto the conductor and drying the slurry; a process of forming an insertion material on the surface of the conductor by immersing the compound membrane in a first potassium chloride aqueous solution and making a distribution of K⁺ in the Prussian blue analog uniform; a process of forming an ion-sensitive stock membrane on the surface of the insertion material by supplying a potassium ion-sensitive membrane stock liquid onto the surface of the insertion material and drying the potassium ion-sensitive membrane stock liquid; and a process of forming a potassium ion-sensitive membrane on the surface of the insertion material by immersing the ion-sensitive stock membrane in a second potassium chloride aqueous solution.

In one example, the method includes a process of producing the slurry. The process of producing the slurry includes a process of synthesizing Prussian blue analogue particles having at least partially a cubic crystal structure by oxidizing a monoclinic Prussian blue analogue.

In one example, the method includes a process of holding a potential of an electrode at an oxidation-reduction potential of K₂FeFe in a K₂SO₄ aqueous solution after the process of forming the potassium ion-sensitive membrane.

In one example, the method includes a process of producing the slurry. The process of producing the slurry includes a process of mixing: Prussian blue analogue particles; acetylene black, Ketjen black, or multi-wall carbon nanotubes; and polyvinylidene fluoride.

Description incorporates the disclosure content of Japanese patent application number 2022-134340, which is the basis for the priority of this application.

### ADVANTAGEOUS EFFECTS OF INVENTION

The all-solid-state potassium ion-selective electrode and the manufacturing method therefor according to the present invention allows further improving the stability of the potassium ion-selective electrode.

### BRIEF DESCRIPTION OF DRAWINGS

FIG. 1 illustrates a configuration of an ion-selective electrode 10 according to Embodiment 1 of the present invention.

FIG. 2 illustrates a part of a process of producing a slurry for forming an insertion material 2 illustrated in FIG. 1.

FIG. 3 shows an example of a result of a X-ray diffraction measurement of a Prussian blue analogue.

FIG. 4 shows an example of a result of a particle size measurement of a Prussian blue analogue.

FIG. 5 illustrates an example of a manufacturing method for the ion-selective electrode 10.

FIG. 6 shows an example of a result of a constant current charge/discharge test.

FIG. 7 shows an example of a result of a natural potential measurement.

FIG. 8 shows reproducibility data for the natural potential measurement shown in FIG. 7.

FIG. 9 shows an example of a result of a long-term stability test.

FIG. 10 shows an example of a result of a polarization test using chronopotentiometry.

FIG. 11 is Nyquist plot as an example of a result of an AC impedance measurement test.

FIG. 12 is an example of how to use the ion-selective electrode 10.

FIG. 13 illustrates a configuration of an electrode device 30 according to Embodiment 2.

FIG. 14 illustrates an example of how to use the electrode device 30 of FIG. 13.

### DESCRIPTION OF EMBODIMENTS

Hereinafter, embodiments of the present invention will be described with reference to the accompanying drawings.

### Embodiment 1

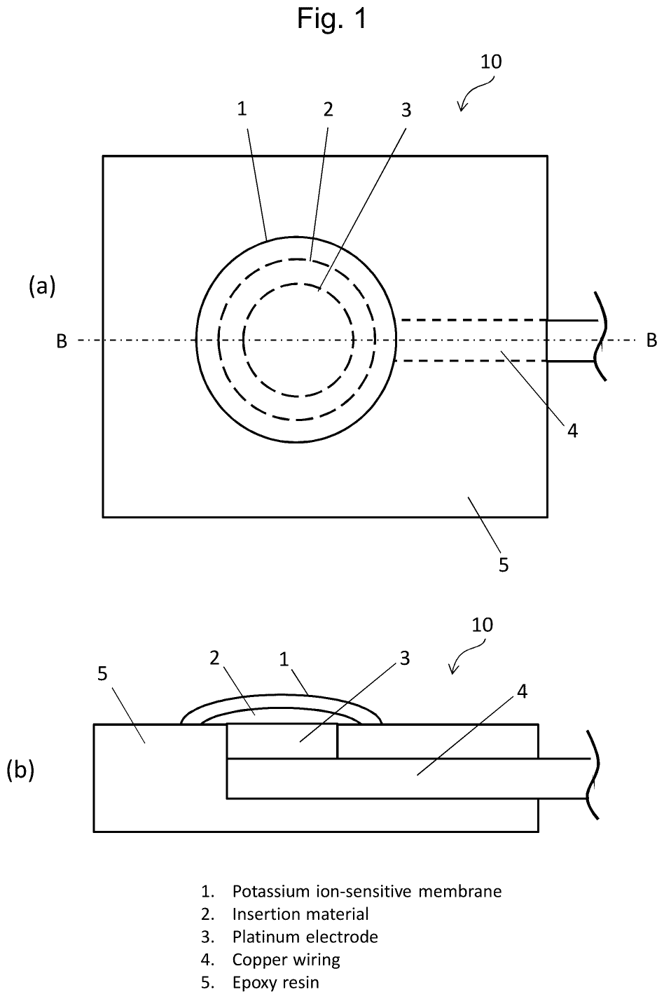

FIG. 1 illustrates a configuration of an ion-selective electrode 10 according to Embodiment 1 of the present invention. The ion-selective electrode 10 is an all-solid-state potassium ion-selective electrode. FIG. 1(a) illustrates a plan view. FIG. 1(b) illustrates a cross-sectional view along the B-B line in FIG. 1(a).

The ion-selective electrode 10 includes an epoxy resin 5, a copper wiring 4 arranged within the epoxy resin 5, a platinum electrode 3 (conductor) connected to the copper wiring 4 and exposed on a surface of the epoxy resin 5, an insertion material 2 formed on a surface of the platinum electrode 3, and a potassium ion-sensitive membrane 1 covering the insertion material 2.

Any insulator can be used in place of the epoxy resin 5. Any conductor can be used in place of the copper wiring 4 and/or the platinum electrode 3.

The insertion material 2 is a mixed material containing Prussian blue analogue particles and conductive material particles. The Prussian blue analogue particles are represented by a structural formula KₓFe[Fe(CN)₆]_{y}·nH₂O. Here, x is a number equal to or greater than 1.5 and equal to or less than 2, and it is preferred to be close to 2. In addition, y is a number greater than 0 and equal to or less than 1, and it is preferred to be close to 0, and n is a number equal to or greater than 0.

The Prussian blue analogue particles have at least partially a monoclinic crystal structure. The Prussian blue analogue particles may partially have a cubic crystal structure.

An example of a manufacturing method for the ion-selective electrode 10 will be described. The manufacturing method includes a process of producing a slurry for forming the insertion material 2, and the ion-selective electrode 10 is produced using the produced slurry. Hereinafter, for a substance containing KₓFeFe, when x is relatively close to 2, it may be written as “K₂FeFe”, but this notation does not necessarily mean that a value of x is 2, nor does it limit a range of x.

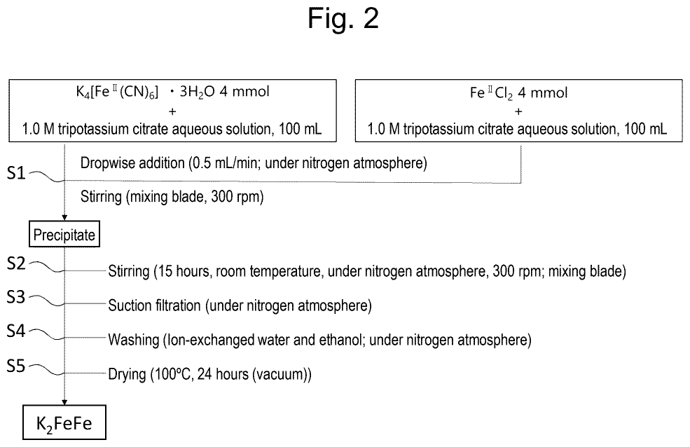

FIG. 2 illustrates a part of a process of producing the slurry for forming the insertion material 2. The process illustrated in FIG. 2 is particularly a process of synthesizing an active material contained in the slurry.

In order to synthesize K₂FeFe contained as an active material in the slurry, 100 mL of a potassium ferrocyanide aqueous solution containing divalent iron ions (4 mmol K₄[Fe^{II}(CN)₆]·3H₂O) is stirred while 100 ml of an aqueous solution of iron(II) chloride (4 mmol Fe^{II}Cl₂) is added dropwise (Step S1). It is preferred to cause these solutions to contain tripotassium citrate (1.0 M), which functions as a grain size controller for K₂FeFe and a K source. The dropwise addition is carried out at a rate of 0.5 mL/min under nitrogen atmosphere, for example. The stirring is carried out at 300 rpm using a mixing blade, for example.

As a result, a white precipitate of a monoclinic Prussian blue analogue is obtained from a sample solution. Accordingly, K₂FeFe is synthesized. The method for synthesizing K₂FeFe is not limited to the one illustrated in FIG. 2, and can be designed as appropriate by a person skilled in the art.

Next, the white precipitate described above is stirred (Step S2). For example, the stirring is carried out at room temperature under nitrogen atmosphere at 300 rpm for 15 hours using a mixing blade. Next, the white precipitate is suction filtered under nitrogen atmosphere (Step S3). Next, the white precipitate is washed (Step S4). The washing is carried out using ion-exchange water and ethanol under nitrogen atmosphere, for example. Since K₂FeFe is an extremely oxidizable substance in the atmosphere, it is preferred to carry out Steps S1 to S4 of the process in FIG. 2 under nitrogen atmosphere as described above to suppress it from oxidizing during the synthesis.

Next, the white precipitate is dried (Step S5). The drying is carried out by, for example, vacuuming at 100° C. for 24 hours.

The powder sample obtained as a result of Step S5 is exposed to the atmosphere for several days. This produces a blue powder of K₂FeFe. This blue powder is Prussian blue analogue particles that contains at least partially a cubic crystal structure, and is an active material for the insertion material 2. The blue powder is considered to be a biphasic coexistence structure of Prussian blue and Prussian white.

As described above, the process of manufacturing the slurry includes a process of synthesizing Prussian blue analogue particles that include at least partially a cubic crystal structure by oxidizing the monoclinic Prussian blue analogue. In the above example, the oxidation was carried out at ambient room temperature by exposing the material to air for several days. However, the oxidation method is not limited to this, and it may be carried out electrochemically or by another method. Alternatively, depending on the composition of K₂FeFe, the oxidation process may be omitted.

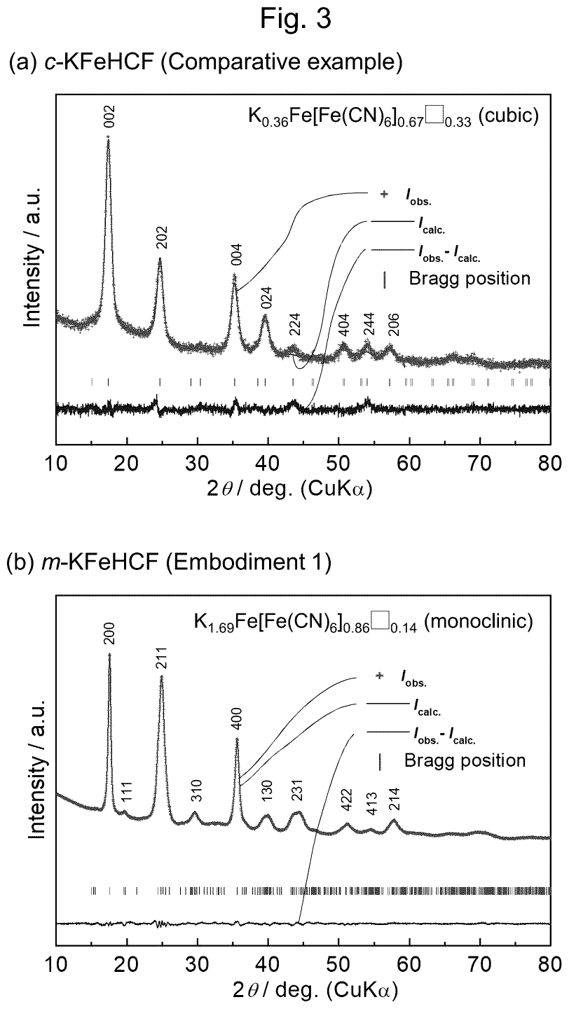

FIG. 3 shows an example of a result of a X-ray diffraction measurement of the Prussian blue analogue. FIG. 3(a) shows a case where x=0.36 and y=0.67 as Comparative example. FIG. 3(b) shows a case where x=1.69 and y=0.86 as one example of the present embodiment. The “□” in the structural formula in FIG. 3 indicates a [Fe(CN)₆] defect.

In Embodiment 1, the Prussian blue analogue in which x=1.69 was used, but the value of x is not limited to 1.69, and for example, it may be 1.65. When x is equal to or greater than 1.5 and equal to or less than 2, it is considered to exhibit equivalent or similar property. Similarly, in Embodiment 1, the Prussian blue analogue in which y=0.86 was used, but it is sufficient that the value of y is greater than 0 and equal to or less than 1. As described above, x is preferred to be close to 2, and y is preferred to be close to 0.

In the figures and description, “cubic crystal system” (cubic) is sometimes abbreviated to “c-” and “monoclinic crystal system” (monoclinic) is sometimes abbreviated to “m-”. For example, “c-KFeHCF” represents a cubic Prussian blue analogue, and “m-KFeHCF”represents a monoclinic Prussian blue analogue.

As shown in FIG. 3(a), a composition with a low potassium content and many defects shows a cubic crystal system phase. As shown in FIG. 3(b), a composition with a high potassium content and few defects shows a monoclinic crystal system phase.

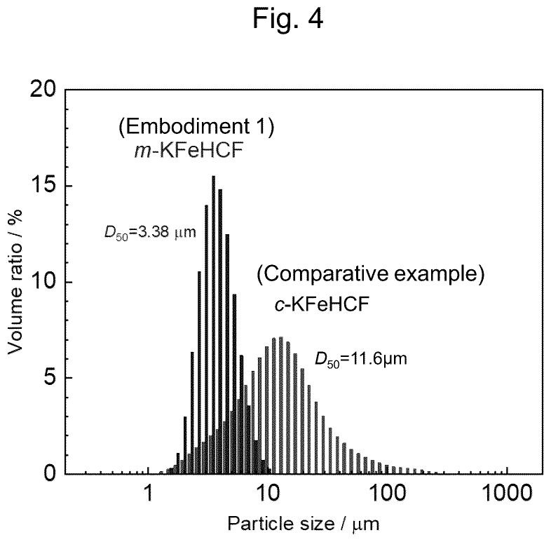

FIG. 4 shows an example of a result of a particle size measurement of the Prussian blue analogue. The horizontal axis represents particle size, and the vertical axis represents volume ratio. Compared with m-KFeHCF according to Embodiment 1, the particle size of c-KFeHCF according to Comparative example is larger because the particles are slightly aggregated.

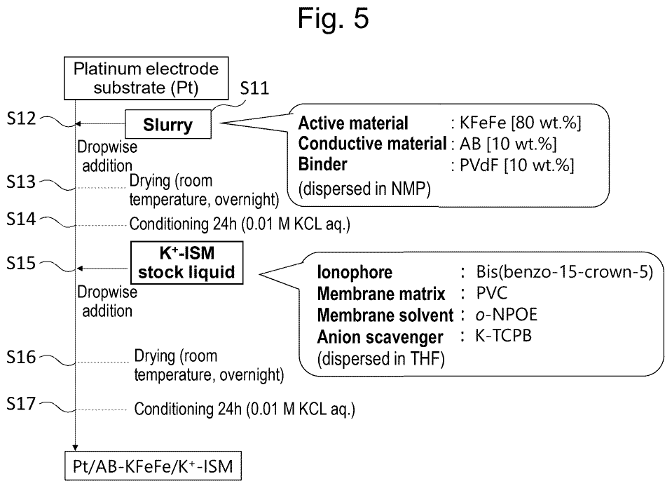

FIG. 5 illustrates an example of a manufacturing method for the ion-selective electrode 10 using the active material thus synthesized. The method includes a process of producing the slurry (Step S11). The process of manufacturing the slurry includes a process of mixing the active material (the Prussian blue analogue particles) synthesized as described above, a conductive material, and a binder. A ratio of active material: conductive material: binder is, for example, 80:10:10 in [weight %].

The conductive material is, for example, acetylene black, Ketjen black, or multi-wall carbon nanotubes, and in the example in FIG. 5, it is acetylene black (AB). The binder is, in the example in FIG. 5, polyvinylidene fluoride dispersed in N-methylpyrrolidone (NMP).

The slurry thus produced is added dropwise onto the platinum electrode 3 (see FIG. 1) (Step S12). A drop volume is, for example, 1 μL. Subsequently, the slurry is dried (Step S13). The drying is carried out, for example, at room temperature overnight. As a result, a compound membrane is formed on a surface of the platinum electrode 3. As described above, the manufacturing method according to Embodiment 1 includes the process of supplying the slurry onto the platinum electrode 3 and drying the slurry to form the compound membrane on the surface of the platinum electrode 3.

As described above, the slurry contains the Prussian blue analogue particles represented by the structural formula KₓFe[Fe(CN)₆]_{y}·nH₂O. The Prussian blue analogue particles have at least partially a monoclinic crystal structure, and x is a number equal to or greater than 1.5 and equal to or less than 2, y is a number greater than 0 and equal to or less than 1, and n is a number equal to or greater than 0.

The compound membrane is then immersed in a 0.01 M KCI aqueous solution (a first potassium chloride aqueous solution) (Step S14). The immersion is carried out for 24 hours, for example. This provides appropriate conditioning. By making distribution of K³⁰ in the Prussian blue analog uniform, it is possible to form the insertion material 2 on the surface of the platinum electrode 3.

Next, the potassium ion-sensitive membrane (K⁺-ISM) stock liquid is added dropwise onto a surface of the insertion material 2 (Step S15). The drop volume is, for example, 50 μL. The potassium ion-sensitive membrane stock liquid includes, for example, an ionophore, a membrane matrix, a membrane solvent, and an anion scavenger. The ionophore is, for example, bis(benzo-15-crown-5). The membrane matrix is, for example, polyvinyl chloride (PVC). The membrane solvent is, for example, o-nitrophenyl octyl ether (o-NPOE). The anion scavenger is, for example, potassium tetrakis(4-chlorophenyl)borate (K-TCPB). Tetrahydrofuran (THF) is used as a dispersant.

Next, the potassium ion-sensitive membrane stock liquid is dried (Step S16). The drying is carried out overnight at room temperature, for example. As a result, the ion-sensitive stock membrane is formed.

As described above, the manufacturing method according to Embodiment 1 includes the process of forming the ion-sensitive stock membrane on the surface of the insertion material 2 by supplying the potassium ion-sensitive membrane stock liquid onto the surface of insertion material 2 and drying the potassium ion-sensitive membrane stock liquid.

Next, the ion-sensitive stock membrane is immersed in a 0.01 M KCI aqueous solution (a second potassium chloride aqueous solution) (Step S17). The immersion is carried out for 24 hours, for example. This provides appropriate conditioning, and the potassium ion-sensitive membrane 1 is formed on the surface of the insertion material 2. Accordingly, the ion-selective electrode 10 illustrated in FIG. 1 is manufactured.

a property of the ion-selective electrode 10 will be described below.

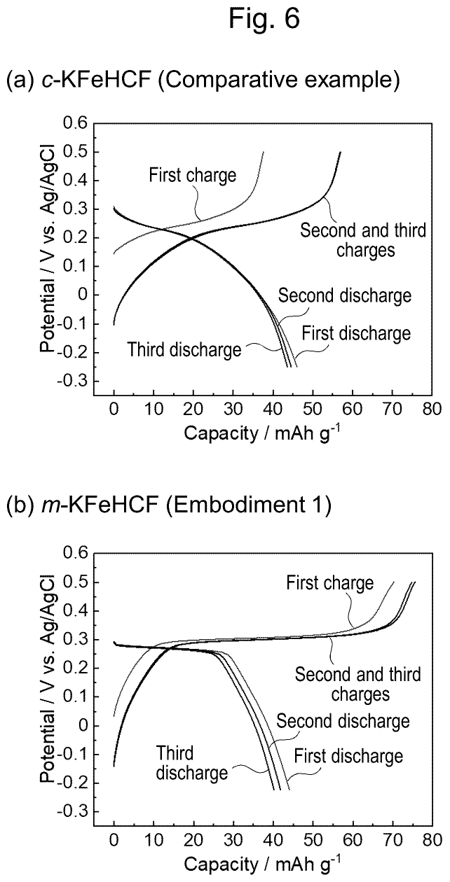

FIG. 6 shows an example of a result of a constant current charge/discharge test. The test was conducted using the following configuration.

Cell: SB9 (two-chamber triple-electrode cell)

Working electrode (the ion-selective electrode 10): PB (Prussian blue): KB (Ketjen black): PVdF (polyvinylidene fluoride)=70:20:10 (weight %)

Counter electrode: AC: KB: PTFE (polytetrafluoroethylene)=80:10:10 (weight %)

Reference electrode: Ag/AgCl (Saturated KCl)

Electrolyte: 0.5M K₂SO₄ aqueous solution

Separator: Glass fiber filter

Current density: 1 C (156 mAg⁻¹)

Voltage range: −0.25 V to 0.50 V vs. Ag/AgCl

In FIG. 6, the horizontal axis represents amounts of charge and discharge, and the vertical axis represents potential. FIG. 6(a) shows a result using the electrode of Comparative example, and is an example where x is less than 1.5 in the structural formula KₓFe[Fe(CN)₆]_{y}·nH₂O. In the following, such a composition may be abbreviated as “c-KFeHCF”. As shown in FIG. 6(a), the electrode of Comparative example shows a sloping potential change, and is considered to be a single-phase reaction.

FIG. 6(b) shows a result of using the electrode according to Embodiment 1, and is an example where x is 1.5 or more in the structural formula KₓFe[Fe(CN)₆]_{y}n·H₂O. In the following, such a composition may be abbreviated as “m-KFeHCF”. As shown in FIG. 6(b), the electrode according to Embodiment 1 shows a stable potential flat region, and is considered to be a two-phase reaction.

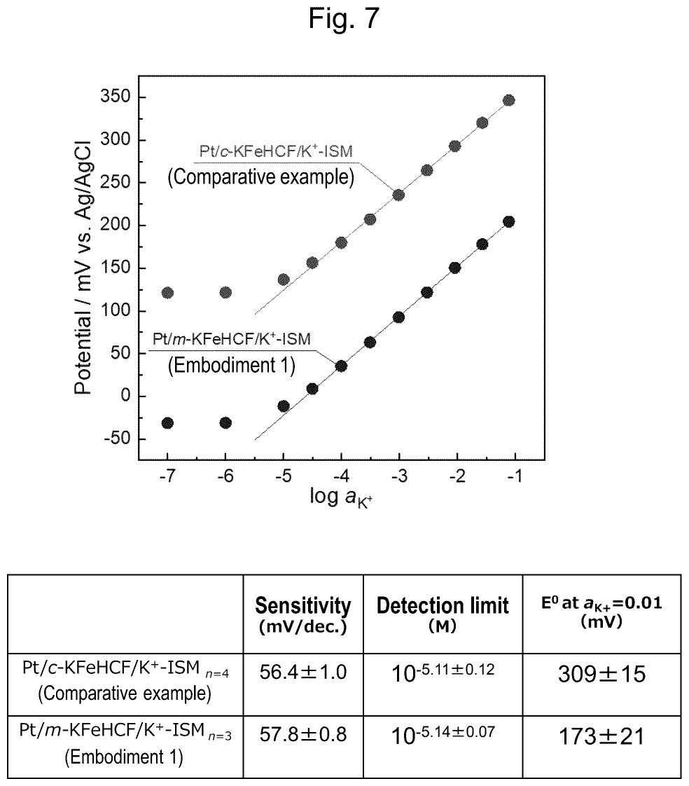

FIG. 7 shows an example of a result of a natural potential measurement. In order to investigate the responsiveness of the prepared electrode to potassium ions, the natural potential was measured in aqueous solutions with different potassium ion concentrations. The horizontal axis represents logarithm of the potassium ion concentration, and the vertical axis represents potential. E⁰ represents an intercept of a calibration curve at a concentration of 0.01.

There was no significant difference in sensitivity or detection limit between the electrode using c-KFeHCF according to Comparative example and the electrode using m-KFeHCF according to Embodiment 1. On the other hand, the absolute value of the potential was lower in Embodiment 1. This is considered to be because the membrane potential was lowered in Embodiment 1 due to the high potassium content and high activity of potassium ions in the crystals.

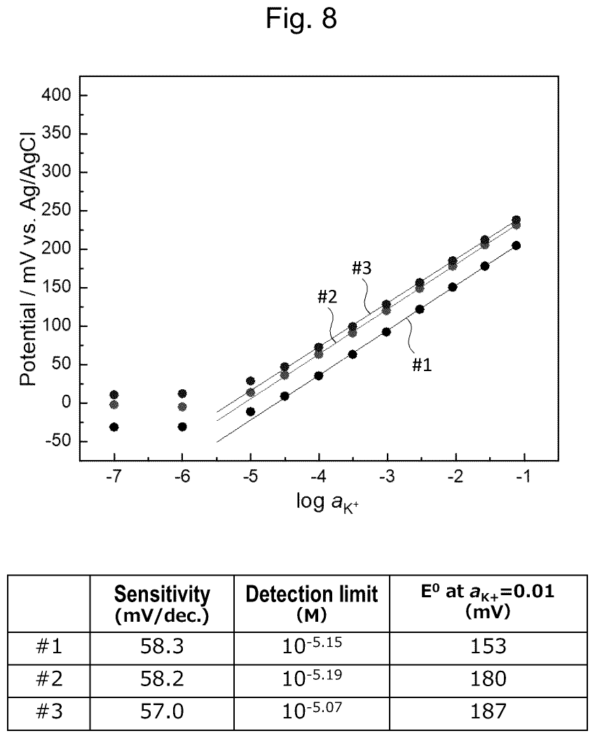

FIG. 8 shows reproducibility data for a natural potential measurement shown in FIG. 7. Three electrodes with the same structure (each indicated as #1 to #3) were fabricated, and the natural potential measurement was performed on each of them.

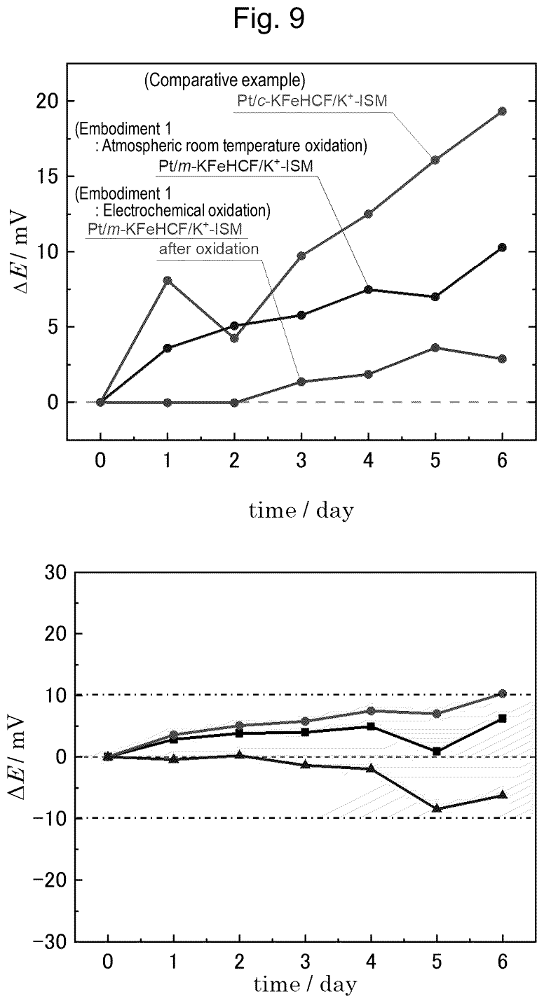

FIG. 9 shows an example of a result of a long-term stability test. The test was carried out in the following configuration. The change in potential of the working electrode relative to the reference electrode was measured.

Working electrode: Potassium ion-selective electrode

Reference electrode: Ag/AgCl (Saturated KCl)

Measurement solution: 10⁻² M KCI aqueous solution

Measurement temperature: Room temperature

In FIG. 9, the horizontal axis represents time (days), and the vertical axis represents potential. FIG. 9(a) shows a measurement result for each of Comparative example and Embodiment 1. The electrode using c-KFeHCF for Comparative example had the worst long-term stability. This is considered to be because, as shown in FIG. 6(a), since the potential curve is sloped, the potential fluctuation is large when a composition change occurs.

As the electrodes using m-KFeHCF according to Embodiment 1, the measurements were performed using a Prussian blue analogue oxidized at ambient room temperature in the process of producing the slurry, and a Prussian blue analogue electrochemically oxidized in the process of producing the slurry. As the electrochemically oxidized electrode, the electrode held at the oxidation-reduction potential of K₂FeFe in a K₂SO₄ aqueous solution was employed. This potential holding allows adjustment of the potassium content within the crystal s, further improving the long-term stability.

When the electrode is oxidized at ambient room temperature, since the potential curve has a flat section as shown in FIG. 6(b), the potential fluctuation during the composition change is small and the stability is high. Furthermore, when the electrode is oxidized electrochemically, the property of the flat section in FIG. 6(b) is more strongly expressed, and the highest long-term stability is exhibited.

FIG. 9(b) shows the reproducibility data for the case where the electrode was oxidized at ambient room temperature in Embodiment 1. Three electrodes with the same structure were prepared, and the long-term stability test was performed on each of them.

As shown in FIG. 9(a), the electrode according to Comparative example exhibited the potential fluctuations of around 20 m V on the sixth day. Whereas, as shown in FIG. 9(a) and 9(b), the electrodes according to Embodiment 1 all exhibited the potential fluctuations of around 10 m V or less on the sixth day.

As described above, the all-solid-state potassium ion-selective electrode according to Embodiment 1 uses K₂FeFe, which is considered to be the biphasic coexistence structure of Prussian blue and Prussian white, as the active material. This suppresses the potential fluctuations to around 10 m V or less, leading to the improved long-term stability of the electrodes.

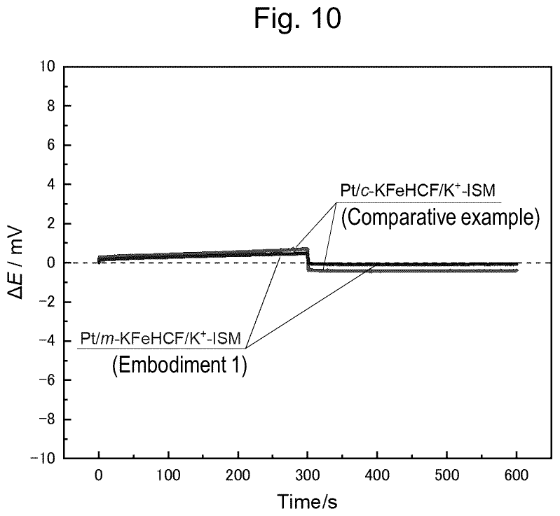

FIG. 10 shows an example of a result of a polarization test using chronopotentiometry. The test was conducted using the following configuration.

Working electrode: Potassium ion-selective electrode

Counter electrode: Pt wire

Reference electrode: Ag/AgCl (Saturated KCI)

Electrolyte: 10⁻² M KCI aqueous solution

Applied current: ±1 nA

Measurement temperature: Room temperature

In FIG. 10, the horizontal axis represents time and the vertical axis represents potential. The direction of the current was reversed at time 300 sec. The results were almost the same as for Comparative example and Embodiment 1.

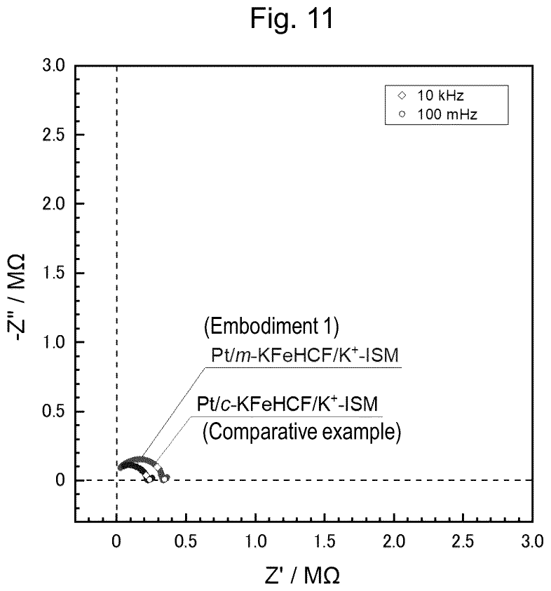

FIG. 11 shows a Nyquist plot as an example of a result of an AC impedance measurement test. The horizontal axis in FIG. 11 represents real part of the impedance, and the vertical axis represents imaginary part. The test was conducted using the following configuration.

Working electrode: Potassium ion-selective electrode

Counter electrode: Pt wire

Reference electrode: Ag/AgCl (Saturated KC1)

Electrolyte: 10⁻² M KCI aqueous solution

Amplitude: 100 mV

Frequency: 100 kHz to 10 mHz

Measurement temperature: Room temperature

The results were almost the same for Comparative example and Embodiment 1. However, Embodiment 1 had slightly lower resistance. This is considered to be because of the small particle size as shown in FIG. 4.

As described above, the all-solid-state potassium ion-selective electrode and the manufacturing method therefor according to Embodiment 1 can improve the stability of the potassium ion-selective electrode.

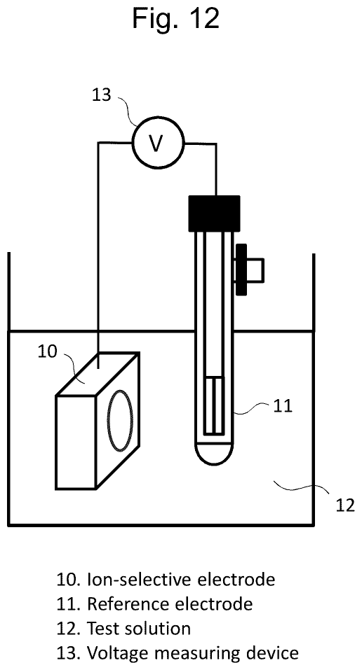

FIG. 12 is an example of how to use the ion-selective electrode 10. The ion-selective electrode 10 and the reference electrode 11 are immersed in a test solution 12. The ion-selective electrode 10 and the reference electrode 11 are electrically connected via a voltage measuring device 13. The voltage measuring device 13 measures the potential difference between the ion-selective electrode 10 and the reference electrode 11, and outputs a signal representing the potential difference. Since the measured potential difference changes depending on concentration of the potassium ions contained in the test solution 12, it is possible to calculate the concentration of potassium ions based on the potential difference.

### Embodiment 2

Embodiment 2 is a modification of a specific configuration of the ion-selective electrode in Embodiment 1. In the following, some of the details common to Embodiment 1 may be omitted.

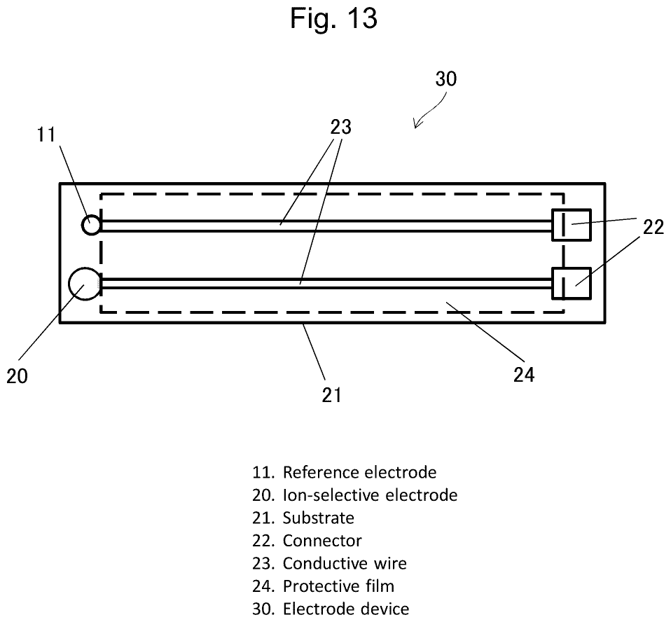

FIG. 13 illustrates a configuration of an electrode device 30 according to Embodiment 2. The electrode device 30 includes a substrate 21, an ion-selective electrode 20, and a reference electrode 11. The substrate 21 is made of alumina, for example. The ion-selective electrode 20 and the reference electrode 11 are formed on the substrate 21.

The ion-selective electrode 20 is an all-solid-state potassium ion-selective electrode, and has the same structure as the ion-selective electrode 10 of Embodiment 1 (however, an insulator part is the substrate 21, not the epoxy resin 5). The ion-selective electrode 20 can be manufactured using the same manufacturing method as the ion-selective electrode 10 of Embodiment 1.

A pair of connectors 22 are formed on the substrate 21. Each of the pair of connectors 22 is connected to the ion-selective electrode 20 and the reference electrode 11 via a conductive wire 23. A part of the surface of the substrate 21, including a region where the conductive wire 23 is formed, is covered with a protective film 24 (shown transparently by a broken line) made of an insulator such as epoxy. The ion-selective electrode 20 and the reference electrode 11 are not covered by the protective film 24, and the connector 22 (at least part thereof) is not covered by the protective film 24.

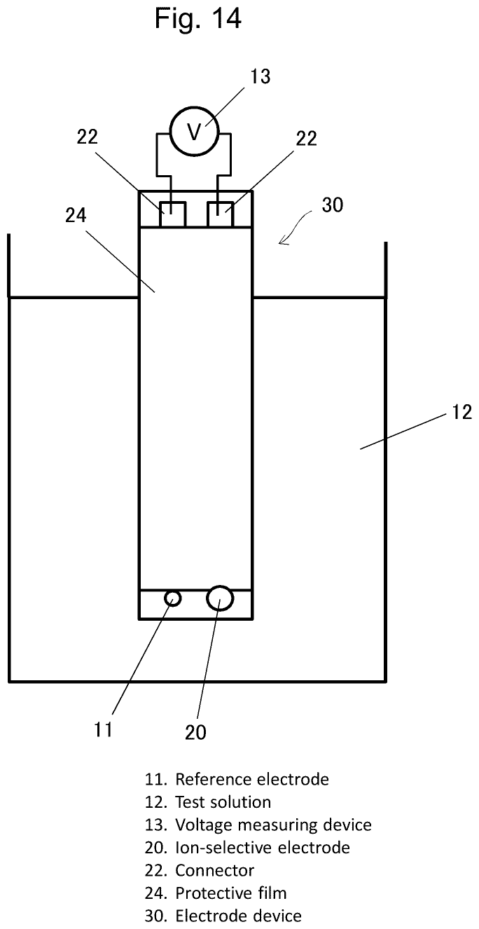

FIG. 14 illustrates an example of how to use the electrode device 30. The ion-selective electrode 20 and the reference electrode 11 are immersed in the test solution 12. The ion-selective electrode 20 and the reference electrode 11 are electrically connected via the voltage measuring device 13. The voltage measuring device 13 measures the potential difference between the ion-selective electrode 20 and the reference electrode 11, and outputs a signal representing the potential difference. Since the measured potential difference changes depending on concentration of potassium ions contained in the test solution 12, it is possible to calculate the concentration of potassium ions based on the potential difference.

Since the all-solid-state potassium ion-selective electrode according to Embodiment 2 has the same structure as that of Embodiment 1 and is manufactured using the same manufacturing method, it is possible to further increase the stability of the potassium ion-selective electrode similarly to the embodiment.

### REFERENCE SIGNS LIST

1 Potassium ion-sensitive membrane
2 Insertion material
3 Platinum electrode (conductor)
4 Copper wiring
5 Epoxy resin
10 Ion-selective electrode (all-solid-state potassium ion-selective electrode)
11 Reference electrode
12 Test solution
13 Voltage measuring device
20 Ion-selective electrode (all-solid-state potassium ion-selective electrode)
21 Substrate
22 Connector
23 Conductive wire
24 Protective film
30 Electrode device

All publications, patents and patent applications cited in this document are incorporated by reference into this document.

1. An all-solid-state potassium ion-selective electrode comprising:
a conductor;
an insertion material formed on a surface of the conductor; and
a potassium ion-sensitive membrane covering the insertion material,
wherein the insertion material material is a mixed material containing Prussian blue analogue particles and conductive material particles,
wherein the Prussian blue analogue particles are represented by a molecular formula KₓFe[Fe(CN)₆]_{y}·nH₂O,
wherein the Prussian blue analogue particles have at least partially a monoclinic crystal structure, and
wherein x is a number equal to or greater than 1.5 and equal to or less than 2, y is a number greater than 0 and equal to or less than 1, and n is a number equal to or greater than 0.

2. A method for manufacturing an all-solid-state potassium ion-selective electrode,
wherein the all-solid-state potassium ion-selective electrode comprises:
a conductor;
an insertion material formed on a surface of the conductor; and
a potassium ion-sensitive membrane covering the insertion material,
wherein the insertion material is a mixed material containing Prussian blue analogue particles and conductive material particles,
wherein the Prussian blue analogue particles are represented by a molecular formula KₓFe[Fe(CN)₆]_{y}·nH₂O,
wherein the Prussian blue analogue particles have at least partially a monoclinic crystal structure,
wherein x is a number equal to or greater than 1.5 and equal to or less than 2, y is a number greater than 0 and equal to or less than 1, and n is a number equal to or greater than 0, and
wherein the method comprises:
applying a slurry onto the conductor and drying the slurry to form a compound membrane on the surface of the conductor;
immersing the compound membrane in a first potassium chloride aqueous solution and making a distribution of K⁺ in the Prussian blue analog uniform to form an insertion material on the surface of the conductor;
applying a potassium ion-sensitive membrane stock liquid onto the surface of the insertion material and drying the potassium ion-sensitive membrane stock liquid to form an ion-sensitive stock membrane on the surface of the insertion material; and
immersing the ion-sensitive stock membrane in a second potassium chloride aqueous solution to form a potassium ion-sensitive membrane on the surface of the insertion material.

3. The method according to claim 2, further comprising
producing the slurry, comprising oxidizing a monoclinic Prussian blue analogue to synthesize Prussian blue analogue particles having at least partially a cubic crystal structure.

4. The method according to claim further comprising
holding a potential of an electrode at an oxidation-reduction potential of K₂FeFe in a K₂SO4 aqueous solution after the immersing the ion-sensitive stock membrane.

5. The method according to claim comprising
producing the slurry, comprising mixing:
Prussian blue analogue particles;
acetylene black, Ketjen black, or multi-wall carbon nanotubes; and
polyvinylidene fluoride.

6. The method according to claim 3, comprising holding a potential of an electrode at an oxidation-reduction potential of K₂FeFe in a K₂SO₄ aqueous solution after immersing the ion-sensitive stock membrane.

7. The method according to claim 2, comprising
producing the slurry, comprising mixing:
Prussian blue analogue particles;
acetylene black, Ketjen black, or multi-wall carbon nanotubes; and
polyvinylidene fluoride.
